(19) United States
(12) Patent Application Publication
(10) Pub. No.: US 2003/0167141 A1
(43) Pub. Date: Sep. 4, 2003

(54) Structural health monitoring

(76) Inventor: Wieslaw J. Staszewski, Sheffield (GB)

Correspondence Address: FISH & RICHARDSON PC, 225 FRANKLIN ST, BOSTON, MA, 02110, US

(21) Appl. No.: 10/027,772

(22) Filed: Dec. 20, 2001

(51) Int. Cl. G06F 19/00

(52) U.S. Cl. 702/77

(57) ABSTRACT

The present invention relates to testing structures or bodies to determine if they contain defects. The defects may be, for example, cracks, delamination etc. Conventional non-destructive testing exploits the non-linearities of such defects. The non-linearities produce intermodulation products in the form of side-bands of an excitation signal. The amplitudes of the side-bands are used to provide an indication of the structural health of the body. However, it has been found that such methods of testing bodies suffer from the vagaries of the environment, temperature and transducer manufacturing tolerances etc. This can lead to inaccurate test results. Suitably, the present invention provides a method for testing a body; the method comprising the steps of comparing first data, representing an excitation signal launched into the body to produce a guided wave within the body, with second data, derived from the body while bearing the guided wave, to identify a phase difference between the first and second data; and determining a measure of the structural integrity of the body using the phase difference. By basing the assessment of the structural body on defect induced phase modulation, more accurate testing can be performed that is independent of at least some of the above-mentioned vagaries.

### FIELD OF THE INVENTION

The present invention relates to structural health monitoring.

### BACKGROUND TO THE INVENTION

Non-destructive testing of structural bodies involves launching waves into, for example, an aircraft wing and measuring the resultant waves. Recently, non-linear non-destructive testing has exploited the non-linear effects that defects in a body under test produce. In particular, second harmonic generation and modulation have been used to assess the distortion of ultrasonic probing signals and vibration signals induced by such defects. The presence of a defect is detected by measuring second harmonics generated by the non-linear distortion of sinusoidal acoustic or vibration signals due to defects in the body. More recently, vibro-acoustic modulation non-destructive testing techniques have been developed in which relatively advanced modulation methods have been used to identify structural defects from the non-linear interaction between an ultrasonic probing signal and vibration in the presence of a defect. The non-linear effect manifests itself as side-band components in the spectrum of the detected signal. The side-bands appear either side of the fundamental frequency of the probing signal. The side-bands provide a valuable insight into the structural well being or otherwise of the body under test.

However, these techniques suffer from a number of fundamental problems. A fundamental problem with vibro-acoustic testing is the sensitivity of the damage detection. The modulation experienced using relatively low frequency waves is only evident in the presence of relatively large defects. When ultrasonic waves are used, although the sensitivity is improved, current signal processing techniques are not sufficiently sophisticated to take advantage of this improvement. Furthermore, the results of using, for example, guided waves in SHM, are known to vary with variations in environmental effects. For example, testing a body on a cold day may lead to different results as compared to testing the same body on a much warmer day. The results can also be influenced by the transducers used for testing and, more particularly, by the quality of the acoustic coupling between the transducers for launching and detecting the probing signal or Lamb waves. Clearly, these variations in the accuracy of any non-destructive test method are undesirable, at best, and, at worst, may lead to a body being certified as structurally sound when that body is, in fact, structurally unsound.

It is an object of the present invention at least to mitigate some of the problems of the prior art

### SUMMARY OF THE INVENTION

Accordingly, a first aspect of the present invention provides a method of determining the structural health of a body; the method comprising the steps of identifying at least one phase characteristic of a signal represented by first data, the first data being derived from the body while beating at least a guided wave produced in response to application of at least one excitation signal to the body, and providing a measure of the structural health of the body using the at least one phase characteristic.

Preferred embodiments provide a method in which the step of identifying the phase characteristic comprises the step of calculating a phase modulation of the first data using

$$φ ( t ) = arctan \frac{\hat{x} ( t )}{x ( t )} ,$$

where \hat{x}(t) is the Hilbert transform of the signal represented by the first data and x(t) is the signal represented by the first data.

Preferably, embodiments provide a method in which the step of providing the measure of structural health comprises the step of determining the amplitude of the phase modulation.

Alternatively, or additionally, embodiments are provided, in which the step of determining the amplitude of the phase modulation comprises the step of determining the maximum amplitude of the phase modulation.

Preferably, embodiments provide a method in which the step of identifying comprises the steps of taking the Fourier transform of the first data and applying the convolution theorem which gives

F[\hat{x}(t)]=\hat{X}(f)=X(f){−jsgn(f)},

where sgn(f) is the signum function defined as

$$sgn ( f ) = \{ \begin{matrix}1 & for f \geq 0 \\ - 1 & for f < 0\end{matrix} , where f is frequency .$$

It has been found that exploiting the phase characteristics of the detected signal provides a method of testing that is independent of variations in environmental conditions and transducer coupling quality or transducer characteristics. Furthermore, the sensitivity of the embodiments of the present invention to damage is improved as compared to the above-described prior art ultra-sonic techniques.

Accordingly, a further aspect of the present invention provides a method for testing a body; the method comprising the steps of comparing first data, representing an excitation signal launched into the body to produce a guided wave within the body, with second data, derived from the body while bearing the guided wave, to identify the phase difference between the first and second data; and providing an indication of the structural health of the body using the phase difference.

Embodiments also provide a method in which the step of identifying comprises the step of comparing the first data with second data, representing a previously determined response of the body to bearing guided wave in response to the excitation signal being launched into the body, to identify a phase difference between the first and second data; and in which the at least one phase characteristic comprises the phase difference.

The embodiments of the present invention advantageously allow improved structural integrity monitoring, that is, one skilled in the art can have greater confidence in the results of any structural integrity monitoring as compared to the prior art

### BRIEF DESCRIPTION OF THE DRAWINGS

Embodiments of the present invention will now be described, by way of example only, with reference to the accompanying drawings in which:

FIG. 1 illustrates a system for non-destructive testing of a body;

FIG. 2 depicts a graph of an excitation signal according to an embodiment; and

FIG. 3 shows a graph of a sampled signal from which the presence of defects in a body can be detected.

### DESCRIPTION OF THE PREFERRED EMBODIMENTS

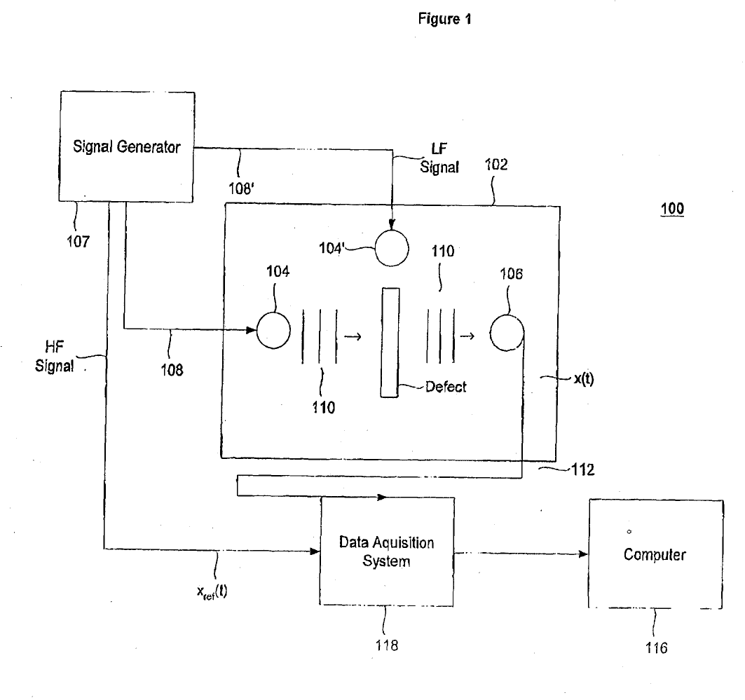

Referring to FIG. 1, there is shown a system 100 for non-destructive testing of a body 102. The system comprises a pair of piezoelectric transducers 104 and 106. The first transducer 104 is used to launch an excitation wave 108 into the body 102. The dimensions of the body 102 and the characteristics of the excitation wave 108 are such that resonant modes of the transducers are stimulated to produce guided waves 110 that propagate within the body. In preferred embodiments the guided-waves are Lamb waves. The mode of stimulation is such that either anti-symmetrical or symmetrical Lamb waves are produced. The second transducer 106 is arranged to detect the guided waves 110. The guided waves 110 cause the second transducer to produce an electrical signal 112. The electrical signal 112 is sampled using a data acquisition system 118 and the data samples are stored within a computer 116.

In the embodiment shown in FIG. 1, the excitation signal 108, used to actuate the first transducer 104, is sampled by a data acquisition system 118. The sampled excitation signal and the sampled guided wave are stored within the computer 116 for later processing.

The first 104 and second 106 transducers are positioned on a surface of the body to be tested due to the spaced-apart nature of the transducers, the portion of the body between the transducers is under test. The first transducer 104 is arranged to produce guided waves 110 within the body 102 that propagate between the transducers. This arrangement has the advantage that the guided waves 110 are influenced by any defects between the two transducers.

In preferred embodiments, the excitation signal comprises at least one of impulse signals, sine waves, that is, a sine burst of a limited number of cycles, and signals with or without an envelope. In preferred embodiments, the excitation signal also comprises a relatively low frequency excitation which is substantially continuous or an impact or impulse signal.

It will be appreciated that the frequency of the excitation signal and the transducers selected to induce and detect the guided waves will depend upon the characteristics of the material from which the body under test is fabricated and the dimensions and shape of the body under test.

Preferred embodiments use two excitation signals or an excitation signal having at least two frequency components. The first signal or component is a relatively high frequency signal. For example, the fist signal or component may have a frequency in the range of 80 kHz to 10 MHz. The frequency of the first signal or component is selected so that the excitation signal induces S₀ or A₀ Lamb wave modes. Alternatively, or additionally, the excitation signal is selected to be as close as possible to a resonant mode of the first transducer. Selecting the excitation signal to be as close as possible to the resonant mode of the first tansducer has the advantage that the amplitude of the excitation signal can be reduced as compared to prior art techniques. The first excitation signal is fed to the first transducer 104.

The second signal or component 108′ has a relatively-low frequency. The frequency of the second signal or component 108′ may be selected to be in the region of a modal frequency, preferably, the first modal frequency, of the body to be analysed. The second signal or component 108′ may have a frequency component in the range of 1 Hz to 10 kHz.

Preferred embodiments produce guided waves within the body under test by applying high 108 and low 108′ frequency signals to respective transducers. For example, the first transducer 104 may be used to car the relatively high frequency component excitation signal 108 while a third transducer 104′ can be used to carry the relatively low frequency component excitation signal 108′.

However, alternative embodiments, rather than launching two excitation waves into the body using respective transducers, launch a single excitation wave, having two frequency components, into the body under test, using a single transducer to carry both frequency components.

In preferred embodiments, the sampling frequency of the transducer for detecting the guided waves is higher than the frequency of the relatively high frequency signal or component. The sampling frequency should preferably be sufficiently high to obtain an acceptable level of resolution in the time domain. Preferably, the sampling frequency is at least 20 times higher than the maximum frequency component of the first excitation signal.

It can be appreciated that the preferred embodiments use a combination of high frequency acousto-ultrasonic signals and low frequency vibrations.

In preferred embodiments, the high frequency and low frequency excitation signals 108 and 108′ are introduced into the body using respective transducers. However, alternative embodiments can be realised in which the two excitation signals are introduced into the body using the same transducer.

Having sampled the guided wave and, in some embodiments, the excitation signal, the data are analysed in the time domain, to identify any phase modulation that can be attributed to damage or defects within the body. If the high frequency acousto-ultrasonic wave has been phase modulated due to a defect, the sampled guided wave has corresponding phase characteristics. For example, the sampled guided wave may lag behind the excitation signal by a phase angle.

According to a first embodiment, a damage index, D, is defined as

D=I−R(τᵢ), (1)

where R(τᵢ) is the cross-correlation function between the reference or excitation signal, x_{ref}(t), and the sampled guided signal, x(t), for a given time-shift or lag of τᵢ. The cross-correlation is given by

$$R ( τ ) = {\sum }_{x = 1}^{N} {x}_{ref} ( t ) x ( t + τ ) , \qquad ( 2 )$$

where N is the number of data samples.

According to the first embodiment, the cross-correlation between the reference signal, x_{ref}(t), and the sampled guided wave signal, x(t), provides an indication of the phase difference between the two signals, that is, an indication of the phase modulation attributable to the damage within the structure. The reference signal may be either the excitation signal, or at least the high frequency component thereof, or previously gathered data of the response of the body to an earlier test signal.

In the embodiment in which the reference signal is the excitation signal, typically the excitation signal will need to be extended since, in some instances, the excitation signal has a relatively short-duration.

In a further embodiment, which uses a Hilbert transform method, the phase modulated signal is obtained from the acousto-ultrasonic signal, x(t), that is, the sampled guided wave, as

$$φ ( t ) = arctan \frac{\hat{x} ( t )}{x ( t )} , \qquad ( 3 )$$

where \hat{x}(t) is the Hilbert transform of x(t). The Hilbert transform of x(t), given in convolution form, is

$$H [ x ( t ) ] = \hat{x} ( t ) = \frac{1}{π} x ( t ) * \frac{1}{t} . \qquad ( 4 )$$

The Hilbert transform may be calculated using the Fourier transform. Taking the Fourier transform of equation (4) and applying the convolution theorem gives

F[\hat{x}(t)]=\hat{X}(f)=X(f){−jsgn(f)}, (5)

where sgn(f) is the signum function defined as

$$sgn ( f ) = \{ \begin{matrix}1 & for f \geq 0 \\ - 1 & for f < 0\end{matrix} , where f is frequency . \qquad ( 6 )$$

The \hat{X} signal in equation (5) is the signal X(f) having had its phase shifted by π/2 for negative frequency components and −π/2 for positive frequency components. Therefore, the Hilbert transform, \hat{x}(t), for x(t) can readily be obtained by taking the Fourier transform, X(f), of x(t); shifting the phase of the Fourier transform according to equation (5) and calculating the inverse Fourier transform, which gives \hat{x}(t), which can then be used in equation (3) to calculate the phase of x(t). The intensity of the variation in the phase of x(t) provides an indication of the damage of the structure.

Alternative embodiments can be realised in which the phase modulation is calculated from the Fouier transform, X(f), of x(t) as follows.

Xₐ(f)=X(f)+j\hat{X}(f)+sgn(f)X(f), (7)

$$\begin{matrix}{X}_{a} ( f ) = X ( f ) + j \hat{X} ( f ) = X ( f ) + sgn ( f ) X ( f ) , \\ = \{ \begin{matrix}0 & if f < 0 \\ X ( f ) & if f = 0 \\ 2 X ( f ) & if f > 0\end{matrix}\end{matrix} \qquad ( 7 )$$

The inverse Fourier transform of the spectrum of the analytic signal, Xₐ(f), will have real and imaginary components related by the Hilbert transform and the phase of the analytic signal, xₐ(t), is given by equation (3) above, that is, the phase of the analytic signal is the instantaneous phase of the signal x(t) given by equation (3). As indicated above, the variation, or modulation, in the instantaneous phase of the sampled signal x(t) provides an indication of the damage of the structure under test.

Once the phase modulation has been established, a damage index, D, can be defined, for some embodiments, as

$$D = \frac{{A}_{φ}}{{A}_{m}} , \qquad ( 8 )$$

where A_{φ} is the amplitude of the instantaneous phase of the sampled guided wave signal relative to the excitation signal and Aₘ is the amplitude of the instantaneous phase of the first or relatively high frequency acousto-ultrasonic excitation signal.

It has been found that the damage index, D, can be normalised according to the severity of damage. At least for metallic structures, the logarithm of D, defined by equation (1) above, follows a crack propagation curve and car be correlated with a stress intensity factor, ΔK, as follows

$$\frac{ⅆ D}{ⅆ n} = {{C}_{D} ( Δ K )}^{{m}_{D}} , \qquad ( 9 )$$

where n is the number of fatigue cycles and C and m are constants for a given material. It can be appreciated that if the subscript D is replaced by L, which represents crack length, the Paris-Erdogan equation follows

$$\frac{ⅆ L}{ⅆ n} = {{C}_{L} ( Δ K )}^{{m}_{L}} . \qquad ( 10 )$$

It can be appreciated from the above that a graph of damage index would be parallel to a crack propagation curve. Therefore, m_{D} and m_{L} are substantially identical in the above equations. C_{D} and C_{L} may be correlated to obtain the crack length, L, from the damage index D. Therefore, providing one skilled in the art can measure, that is, observe a crack, the crack length can also be determined using the damage index, D. Furthermore, a damage prognosis based on D may utilise fatigue analysis theory.

Using embodiments of the present invention, cracks having a length of between 0.5 mm and 1 mm, at a depth of 0.2 mm to 2 mm, have been detected in plates of 750 mm×300 mm×2 mm. Embodiments of the present invention have been realised using two piezoceramic transducers, which were Sonox P5's having a 0.25 inch diameter and a 0.01 inch thickness. They were located at a distance of approximately 45 mm from a crack and arranged such that the growing crack was between the transducers. The excitation signal was a five-cycle burst sine wave having a frequency of 410 kHz and an amplitude of 5V. The low frequency excitation signal was a 100 Hz sine wave induced by a GW Type V4 Shaker and a GW power amplifier. Both excitation signals were generated using a TTi TGA 1230 Arbitrary Waveform Generator. A LeCroy oscilloscope was used to capture the data at a sampling frequency of 25 MHz.

The above embodiments have been described with reference to the use of piezo-ceramic transducers. These transducers have the advantage that they can be integrated into the structures to be analysed and used as both actuators and sensors. However, other transducers way equally well be used. For example, classical wedge-webs may be used to launch the Lamb waves. Optical transducers can be used to detect the response of the body to the presence of the Lamb waves.

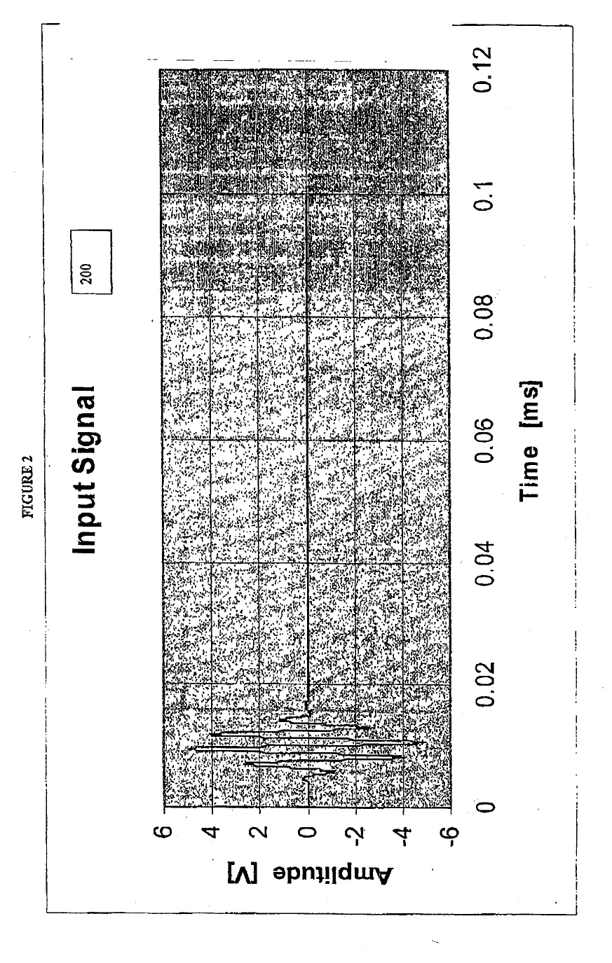

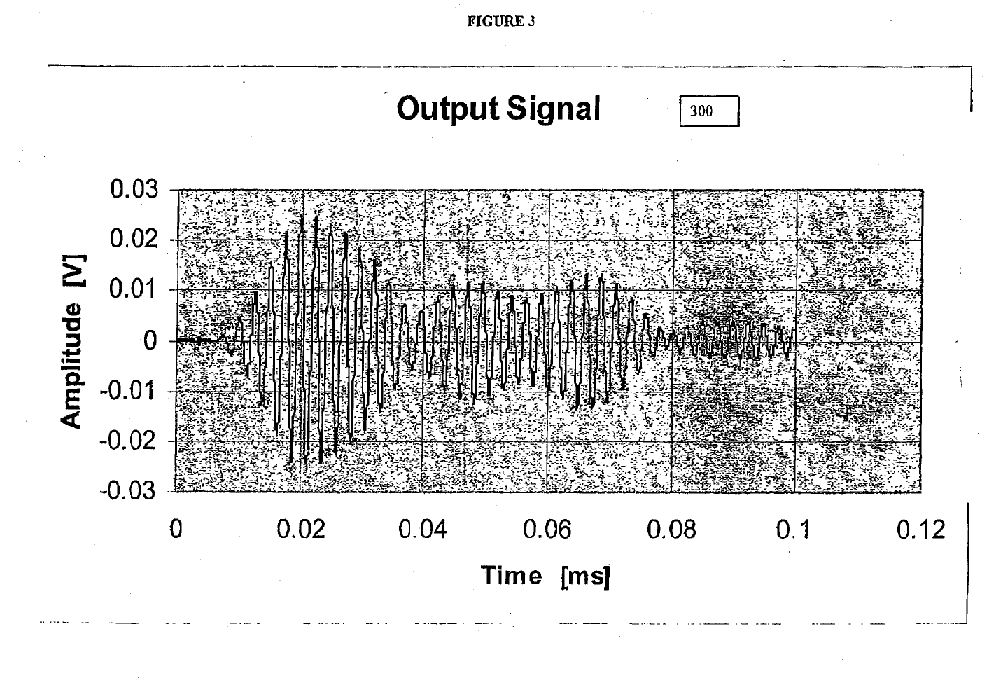

Referring to FIG. 2, there is shown a graph 200 of an HF excitation signal, or at least an HF component thereof, according to an embodiment. The excitation signal is a burst sine wave. FIG. 3 shows a graph 300 of the output of the second transducer that is arranged to detect the guided waves. It can be appreciated in the embodiments shown that the excitation signal has a significantly greater duration as compared to the guided wave. It is for this reason that the excitation signal may need to be extended. In duration if it is to be used as a reference signal.

Although the above embodiments have been described with reference to the Hilbert transform and correlation function, embodiments are not limited to such a transform. Other embodiments can be realised in which a wavelet-based procedure is used. Such a wavelet-based procedure is described in, for ample, W. J. Staszewski, Wavelets for Mechanical and Structural Damage Identification, Studia i Materialy, Monograph No. 510/1469/2000, Polish Academy of Sciences Press, Gdansk, 2000, which is incorporated herein by reference for all purposes. Alternatively, or additionally, one skilled in the art may use the procedures described in, for example, S. Patsias and W. J. Staszewski, A survey of signal demodulation algorithms for fault detection in machinery and structures, a copy of which is included in Appendix A. Other analysis techniques are described in A. Kyprianou and W. J. Staszewski, 1999, “On the Cross Wavelet Analysis of Duffing Oscillator”, Journal of Sound and Vibration, Vol. 228, No. 1, pp.199-210, which is incorporated herein by reference for all purposes.

Although the above embodiments have been described with reference to the use of two transducers, embodiments of the present invention are not limited thereto. Embodiments can be realised in which a number of transducers are used. The transducers may be distributed in a predetermined manner, relative to the first or excitation transducer, across a surface of a body. Since the spatial relationship between the transducers is known in advance, this can be taken into account when implementing embodiments of the present invention.

While the excitation signals in the above embodiments have been chosen to excite A₀ or S₀ mode guided waves, the present invention is not limited thereto. Embodiments cal equally well be realised in which the excitation signal is chosen based on the resonant characteristics of the transducers. Selecting the excitation signal based on the resonant characteristics of the transducers has the advantage that, at least for some transducers, the electro-mechanical coupling is improved as compared to using those transducers to produce S₀ or A₀ waves. Preferred embodiments select the transducers and excitation signals such that the S₀ or A₀ modes are produced at frequencies that are close to the resonant modes of the transducers.

Furthermore, the modes of the Lamb waves used in the embodiments of the present invention are not limited to being either S₀ or A₀ modes. A combination of these modes could equally well be used. Still farther, higher order guided wave modes could be used either jointly or severally with the other above-described modes. The present invention has the advantage over classical methods, which are limited to S₀ or A₀ modes, that the embodiments are still effective in the presence of mode conversion, which will inevitably happen in complex structures given the boundary conditions.

Embodiments can be realised in which the reference signal is derived from the body before it has been commissioned and the signal resulting from the guided waves is compared with that previously derived reference signal. It can be appreciated that this is in contrast to the above embodiments in which the reference signal and the signal derived from the resulting guided waves are produced substantially concurrently.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method of determining the structural health of a body; the method comprising the steps of identifying at least one phase characteristic of a signal represented by first data, the first data being derived from the body while bearing at least a guided wave produced in response to application of at least one excitation signal to the body, and providing a measure of the structural health of the body using the at least one phase characteristic.

2. A method as claimed in any preceding claim, in which the step of identifying the phase characteristic comprises the step of calculating a phase modulation of the first data using
$$φ ( t ) = arctan \frac{\hat{x} ( t )}{x ( t )} ,$$
where \hat{x}(t) is the Hilbert transform of the signal represented by the first data and x(t) is the signal represented by the first data.

3. A method as claimed in claim 2, in which the step of providing the measure of structural health comprises the step of determining the amplitude of the phase modulation.

4. A method as claimed in claim 3, in which the step of determining the amplitude of the phase modulation comprises the step of determining the maximum amplitude of the phase modulation.

5. A method as claimed in any preceding claim, in which the step of identifying comprise the steps of taking the Fourier transform of the first data and applying the convolution theorem which gives
F[\hat{x}(t)]=\hat{X}(f)=X(f){−jsgn(f)},
where sgn(t) is the signum function defined as
$$sgn ( f ) = \{ \begin{matrix}1 & for & f \geq 0 \\ - 1 & for & f < 0\end{matrix} , where f is frequency .$$

6. A method as claimed in claim 1, in which the step of identifying comprises the step of comparing the first data with second data, representing the excitation signal launched into the body to produce a guided wave within the body, to identify a phase difference between the first and second data; and in which the at least one phase characteristic comprises the phase difference.

7. A method as claimed in claim 1, in which the step of identifying comprises the step of comparing the firs data with second data, representing a previously determined response of the body to bearing a guided wave produced in response to the excitation signal being launched into the body, to identify a phase difference between the first and second data; and in which the at least one phase, characteristic comprises the phase difference.

8. A method as claimed in either of claims 6 and 7, in which the phase difference is calculated using a cross-correlation function
$$R ( τ ) = {\sum }_{t = 1}^{N} {x}_{ref} ( t ) x ( t + τ ) ,$$
where R(τᵢ) is the cross-correlation function between the first and second data and N is the number of data samples of the first and second data.

9. A method as claimed in claim 8, in which the measure of structural health is given by at least one of D=1−R(τᵢ) or D=1/R(τᵢ).

10. A method as claimed in any of claims 6 to 9, in which the step of providing comprises the step of identifying the magnitude of the instantaneous phase difference between the first and second data.

11. A method as claimed in any preceding claim, in which the guided wave is a Lamb wave.

12. A method as claimed in any preceding claim, further comprising the steps of attaching a first transducer to file body and applying the excitation signal to the first transducer to induce the propagation of the guided wave within the body.

13. A method as claimed in any preceding claim, further comprising the step of attaching a second transducer to the body and measure the response of the second transducer to the presence of the guided wave.

14. A method as claimed in any preceding claim, further comprising the steps of applying a third transducer to the body and applying a second excitation signal to the third transducer.

15. A method as claimed in any preceding claim, in which the excitation signal applied to a transducer is arranged to produce a guided wave having a predetermined frequency.

16. A method as claimed in claim 15, in which the predetermined frequency is selected according to the dimensions of an anticipated defect within the body.

17. A method as claimed in any preceding claim, in which the excitation signal is arranged to have at least one predetermined frequency component.

18. A method as claimed in claim 17, in which the at least one predetermined frequency component comprises at least one frequency component that is related to at least one of a desired mode of propagation of the guided wave and the thickness of the material under test, preferably, the at least one predetermined frequency component comprises at least one frequency component in the range 80 kHz to 10 MHz.

19. A method as claimed in either of claims 17 and 18, in which the at least one predetermined frequency component comprises at least one frequency component in the range 1 Hz to 10 kHz.

20. A method as claimed in any preceding claim, in which the excitation frequency is selected to induce a predetermined mode of propagation of the guided wave within the body.

21. A method as claimed in any preceding claim, in which the excitation signal predetermined frequency is selected according to a resonant mode of the first transducer.

22. A method as claimed in any of claims 6 and 21, in which the step of providing the measure of structural health comprises the step of comparing the amplitude of the phase modulation with the amplitude of the excitation signal.

23. A method for monitoring the structural integrity of a body substantially as described herein with reference to and/or as illustrated in the accompanying drawings.

24. An apparatus for determining the structural health of a body; the apparatus comprising means for identifying at least one phase characteristic of a signal represented by first data, the fist data being derived from the body while bearing at least a guided wave produced in response to application of at least one excitation signal to the body, and means for providing a measure of the structural health of the body using the at least one phase characteristic.

25. An apparatus as claimed in claim 24, in which the means for identifying the phase characteristic comprises means for calculating a phase modulation of the first data using
$$φ ( t ) = arctan \frac{\hat{x} ( t )}{x ( t )} ,$$
where \hat{x}(t) is the Hilbert transform of the signal represented by the first data and x(t) is the signal represented by the first data.

26. An apparatus as claimed in claim 25, in which the means for providing the measure of structural health comprises means for determining the amplitude of the phase modulation.

27. An apparatus as claimed in claim 26, in which the means for determining the amplitude of the phase modulation comprises means for determining the maximum amplitude of the phase modulation.

28. An apparatus as claimed in any of claims 24 to 27, in which the means for identifying comprises means for taking the Fourier transform of the first data and means for applying the convolution theorem which gives
F[\hat{x}(t)]=\hat{X}(f)=X(f){−jsgn(f)},
where sgn(f) is the signum function defined as
$$sgn ( f ) = \{ \begin{matrix}1 & for & f \geq 0 \\ - 1 & for & f < 0\end{matrix} , where f is frequency .$$

29. All apparatus as claimed in claim 24, in which the means for identifying comprises means for comparing the first data with second data, representing the excitation signal launched into the body to produce a guided wave within the body, to identify a phase difference between the first and second data; and in which the at least one phase characteristic comprises the phase difference.

30. An apparatus as claimed in claim 24, in which the means for identifying comprises means for comparing the first data with second data, representing a previously determined response of the body to bearing a guided wave produced in response to the excitation signal launched being launched into the body, to identify a phase difference between the first and second data; and in which the at least one phase characteristic comprises the phase difference.

31. An apparatus as claimed in either of claims 29 and 30, in which the phase difference is calculated using a cross-correlation function
$$R ( τ ) = {\sum }_{t = 1}^{N} {x}_{ref} ( t ) x ( t + τ ) ,$$
where R(τᵢ) is the cross-correlation function between the first and second data and N is the number of data samples of the first and second data.

32. An apparatus as cleaned in claim 31, in which the measure of structure health is given by at least one of D=1−R(τᵢ) or D=1/R(τᵢ).

33. An apparatus as claimed in any of claims 29 to 32, in which the means for providing comprises means for identifying the Solitude of the instantaneous phase difference between the first and second data.

34. An apparatus as claimed in any of claims 24 to 33, in which the guided wave is a Lamb wave.

35. An apparatus as claimed in any of claims 24 to 34, flier comprising means for attaching a first transducer to the body and means for applying the excitation signal to the first transducer to induce the propagation of the guided wave with the body.

36. An apparatus as claimed in any of claims 24 to 35, further comprising means for attaching a second transducer to the body, and means for measuring the response of the second transducer to the presence of the guided wave.

37. An apparatus as claimed in any of claims 24 to 36, further comprising means for applying a third transducer to the body and means for applying a second excitation signal to the third transducer.

38. An apparatus as claimed in any of claims 24 to 37, in which the excitation signal applied to the transducer is arranged to produce a guided wave having a predetermined frequency.

39. An apparatus as claimed in claim 38, in which the predetermined frequency is selected according to the dimensions of an anticipated defect within the body.

40. An apparatus as claimed in any of claims 24 to 39, in which the excitation signal is arranged to have at least one predetermined frequency component.

41. An apparatus as claimed in claim 40, in which the at least one predetermined frequency component comprises at least one frequency component that is related to at least one of desired mode of propagation of the guided wave and the thickness of the material under test and preferably comprises at least one frequency component in the range 80 kHz to 10 MHz.

42. An apparatus as claimed in either of claims 40 and 41, in which the at least one predetermined frequency component comprises at least one frequency component in the range 1 Hz to 10 kHz.

43. An apparatus as claimed in any of claims 24 to 42, in which the excitation frequency is selected to induce a predetermined mode of propagation of the guided wave within the body.

44. An apparatus as clamed in any of claims 24 to 43, in which the excitation signal predetermined frequency is selected according to a resonant mode of the first transducer.

45. An apparatus as claimed in any of 24 to 44, in which the means for providing the measure of structural health comprises means for comparing the amplitude of the phase modulation with the amplitude of the excitation signal.

46. An apparatus for monitoring the structural integrity of a body substantially as described herein with reference to and/or as illustrated in the accompanying drawings.

47. A computer program element for implementing a method or system as claimed in any preceding claim.

48. A computer program product comprising a computer readable storage medium having stored thereon a computer program element as claimed in claim 47.
